(19) United States
(12) Patent Application Publication
(10) Pub. No.: US 2008/0257379 A1
(43) Pub. Date: Oct. 23, 2008

(54) Method and equipment for the treatment of a surface of a work piece

(76) Inventors: Christian Buske, Steinhagen (DE); Peter Fornsel, Spenge (DE)

Correspondence Address: PROSKAUER ROSE LLP, ONE INTERNATIONAL PLACE, BOSTON, MA, 02110, US

(21) Appl. No.: 12/042,636

(22) Filed: Mar. 5, 2008

(30) Foreign Application Priority Data
Mar. 6, 2007 (DE) 10 2007 011 235.3

(51) Int. Cl. B08B 6/00

(52) U.S. Cl. 134/1.1; 134/201

(57) ABSTRACT

A method for treating the surface of a work piece includes exposing the surface to be treated to a beam of electromagnetic radiation, and simultaneously exposing an area of the surface exposed to the beam of electromagnetic radiation at least partially to a plasma beam. This method provides an improved pretreatment, in particular cleaning of the surface of a work piece, by, at least in part, energy density enhancements of each of the beam of electromagnetic radiation and the plasma beam.

### CROSS-REFERENCE TO RELATED APPLICATIONS

This application is claims the benefit of and priority to German patent application no. DE 10 2007 011 235.3, filed Mar. 6, 2007; the disclosure of which is incorporated herein by reference in its entirety.

### FIELD OF THE INVENTION

The invention relates to a method and device for treating the surface of a work piece.

### BACKGROUND

In numerous processes, it is necessary to pretreat, in particular clean, a surface of a work piece prior to further treatment. Cleaning here involves stripping the substances adhering to the surface and removing as much residue as possible, so that the surface can then be further treated largely without any disruptive influence by adhering substances. Possible substances include oil residue, lubricant, coatings or other organic or inorganic substances that adheres to the surface.

References made below to a laser beam are not to be construed as limiting. Any beam of electromagnetic radiation desired can be used in place of the laser beam, provided the electromagnetic radiation beam has a sufficient energy density for performing the treatment.

In a laser beam treatment, the laser beam is moved along a path on the surface to be treated and/or cleaned, wherein the width of the path essentially corresponds to the width of the laser beam in the exposed area. The radiation energy of the laser beam is absorbed by the substances adhering to the surface, thereby causing the substances to evaporate or burst from the surface.

The disadvantage to laser treatment is the small path width of the laser beam on the surface, so that the laser beam has to be moved back and forth frequently to enable extensive treatment. Another disadvantage is that the substances detached from the surface again become deposited on the surface, since, while they were detached, they were not additionally reacted with each other or the ambient air so as to undergo a conversion that would avoid renewed deposition.

By contrast, plasma treatment involves first generating an atmospheric plasma beam and then aiming it at a surface. Plasma treatment takes the form of an interaction between the plasma beam and the surface.

The power supply for plasma treatment is preferably generated with a plasma source and/or plasma die, in which a plasma beam is generated from a working gas by means of a non-thermal discharge during exposure to a high-frequency high voltage in a die pipe between two electrodes. This results in a high-frequency sequence of discharges between the electrodes of the plasma die, wherein no thermal equilibrium comes about in the discharge area. As a result, the imbalance between electron temperature and ion temperature can be maintained even during continuous operation. Because the working gas here is preferably under atmospheric pressure, reference is here also made to atmospheric plasma.

The plasma beam exits the die opening, wherein one of the two electrodes is situated in the area of the die opening. The non-thermal plasma beam preferably has no electrical streamers, i.e., discharge channels for electrical discharge, outside the plasma die given a suitably adjusted flow rate, so that only the energy-rich, but low-heated plasma beam is directed at the surface. Such an atmospheric plasma beam is also referred to as a potential-free plasma beam. The voltage difference between the die opening and work piece here preferably measures below 100 V.

Reference is made to a high electron temperature and low ion temperature in describing the gas properties of the plasma beam. The high electron temperature produces a high reactivity of the plasma gas or plasma gas mixture. By contrast, the low ion temperature generates a low level of thermal energy, which is transmitted to the surface as the plasma beam hits said surface.

Known from the prior art disclosed in EP 0 761 415 A1 and EP 1 335 641 A1 are such plasma sources. The rotating dies known from WO 99/52333 and WO 01/43512 are suitable for using the plasma beam over a larger surface.

The plasma beam is preferably generated using an atmospheric discharge in a working gas containing oxygen. This increases the reactivity of the plasma beam. Air is preferably used as the working gas. In like manner, a working gas consisting of a mixture of hydrogen and nitrogen can be used, i.e., a so-called forming gas. Only nitrogen is possible as the working gas.

Of course, the effectiveness of plasma treatment depends on the selection of process gas, the power, the treatment duration and system concept, and adjustments can be introduced as required. In particular, the voltage variables frequency and amplitude as well as the flow rate of the working gas represent suitable means for influencing the effectiveness of plasma treatment.

In the prior art described in DE 37 33 492, the atmospheric plasma beam is generated via a corona discharge by ionizing a working gas, such as air. The device consists of a ceramic pipe enveloped by an outer electrode on the outer wall. An inner electrode is arranged as a rod with a few millimeters distance from the inner wall of the ceramic pipe. An ionizable gas like air or oxygen is passed through the gap between the inner wall of the ceramic pipe and the inner electrode. A high-frequency high voltage field of the kind used in a corona pretreatment of films is applied to the two electrodes. The flowing gas is ionized by the alternating field, and exits the pipe end.

Also known is to generate an atmospheric plasma beam using an alternating voltage field with a frequency in the megahertz range, for example a microwave field, in a working gas. This excitation mode is not accompanied by the generation of a gas discharge, and is hence less efficient than the plasma source described first.

However, in the end, the type of working gas excitation used for plasma generation is not important, as long as a plasma beam of sufficient intensity can be generated.

The surface area exposed to the plasma beam absorbs the energy, thereby causing the adhering substances to detach. The spatial propagation of the plasma beam here results in an energy absorption by the substances after their actual detachment from the surface, so that a post-reaction can take place. The substances converted in this way are then at least partially no longer able to again become deposited on the surface. In addition, the plasma beam is linked with an intensive gas stream that helps remove the detached substances.

However, one disadvantage to plasma treatment can be that the energy density is too low to achieve a complete and/or sufficient cleaning in a single exposure of the surface. For this reasons, certain applications require repeated exposure of the surface to the plasma beam. Another disadvantage is that oils, for example, are not completely detached in a treatment step, and that the residual oil solidifies, in particular resinifies. This is accompanied by the effect that residual oil flows together again owing to the low viscosity, once again ruining the cleaning effect. The effectiveness of plasma treatment can therefore be improved.

Another application of plasma treatment involves plasma coating, as described in WO 01/32949. The problem here as well is that the surface must be flawlessly pretreated.

### SUMMARY OF THE INVENTION

Therefore, an aspect of the invention is to indicate a method and device that enable an improved pretreatment, in particular cleaning of a surface of a work piece.

In general, a method for treating the surface of a work piece according to the invention includes exposing the surface to be treated to a beam of electromagnetic radiation, and simultaneously exposing at least a portion of an area of the surface exposed to the beam of electromagnetic radiation to a plasma beam.

The method is based on the knowledge that the properties of the beam of electromagnetic radiation, in particular a laser beam with a sufficiently high energy density for detaching the adhering substances, and the properties of the plasma beam with its expanded volume and intensive gas flow improve pretreatment, in particular the cleaning of a surface. An atmospheric plasma beam is a preferred embodiment of the plasma beam. A surface cleaned with the described method can be further treated in a particularly stable manner, e.g., bonding with another work piece can be significantly improved.

The two cleaning effects of the laser beam on the one hand and the plasma beam on the other are not just added together, but rather the energy densities from both beams enhance each other in terms of their effects. For example, the laser treatment involves intensive actions with a very high energy density on a small surface, while the energy density of the plasma beam is lower, and is spread out over a larger area. Therefore, the plasma beam precleans, so that the laser beam no longer has to perform all the cleaning work. As a result, the laser beam can be expanded or focused less strongly, so that the path width covered by the laser beam is widened while keeping the cleaning effect at least the same. In addition, the plasma beam triggers a reaction of the detached substances that cannot be induced by exposure to the laser beam only. In addition, the blowing effect of the plasma beam leads to a uniform removal of the substances detached by the laser beam. As a result, the plasma beam not only precleans, but also ensures an effective conversion and continuous removal of the detached substances or their reaction products.

In one embodiment, the area exposed to plasma is completely enveloped in a preferred manner by the area exposed to the laser beam. This yields a complete and effective treatment of the surface.

In an embodiment, the area exposed to the plasma is preferably larger than the area exposed to the laser beam. This yields a complete exposure of the volume around the laser beam, preventing the substances from again becoming deposited in a larger area. In addition, moving the laser beam in conjunction with the plasma beam exposes the area of the surface to be treated with a portion of the plasma after exposed to the laser beam.

In an embodiment of the method, the laser beam is essentially aligned parallel to the direction of plasma beam propagation. This results in a maximum overlap of the areas covered by the two beams. An essentially parallel alignment here implies that the axis of the laser beam is aligned parallel or at a very small angle of a few degrees relative to the main direction of propagation of the plasma beam. This is because the plasma beam does not propagate exclusively in one direction, but rather propagates in a fan-like manner. In most instances, the plasma beam can be assumed to be rotationally symmetrical, so that the direction of the laser beam can be aligned relative to the symmetrical axis of the plasma beam. In one particularly effective further development of the described method, the area of the surface exposed to the laser beam and plasma is also treated via plasma polymerization. The extensive pretreatment with the laser beam and plasma beam is then directly utilized for a readily adhering coating with a coating generated via plasma polymerization.

In this case, plasma polymerization can advantageously be performed alternately or simultaneously with the process of exposing the surface to the laser beam and plasma beam.

In another aspect, the invention is directed to a device for treating the surface of a work piece with means for exposing the surface to be treated to a beam of electromagnetic radiation and means for at least partially exposing the area of the surface exposed to the beam of electromagnetic radiation to a plasma beam. Further embodiments of this device are described below.

### DETAILED DESCRIPTION OF THE DRAWINGS

The invention will be described in greater detail below based on exemplary embodiments, wherein reference is made to the attached drawing. The drawing shows:

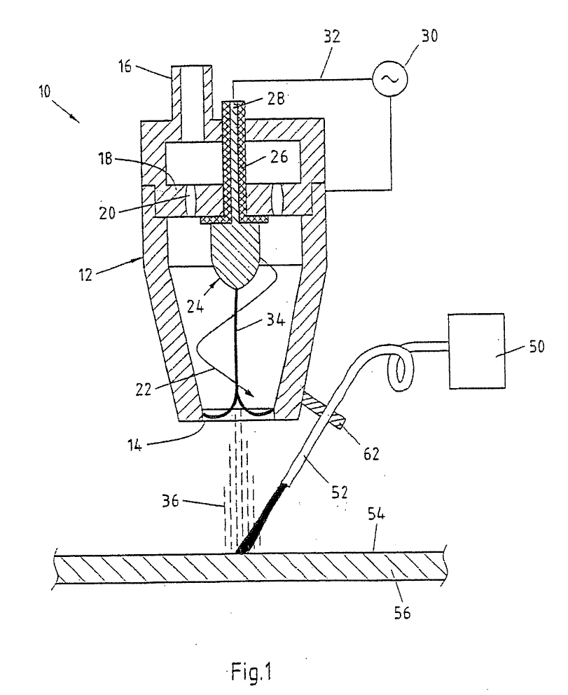

FIG. 1 a first exemplary embodiment of a device according to the invention,

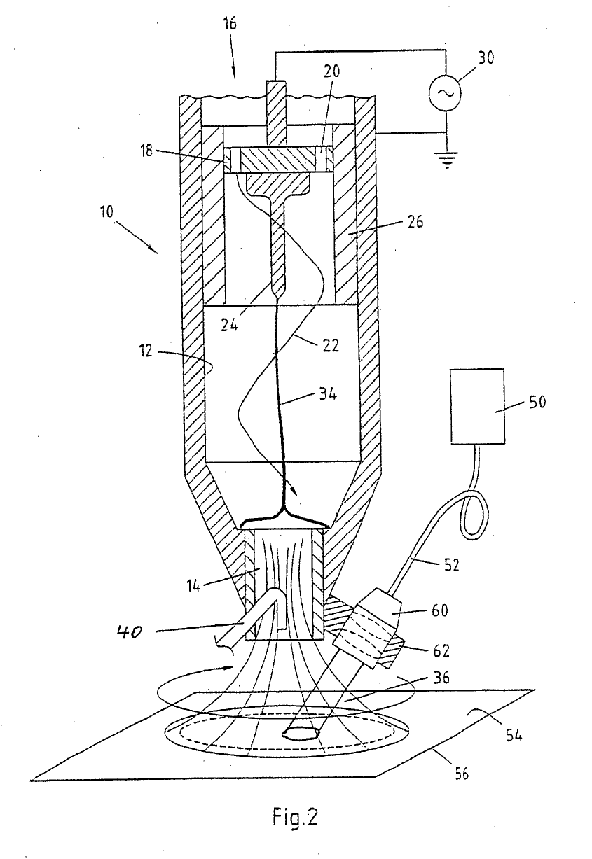

FIG. 2 a second exemplary embodiment of a device according to the invention, and

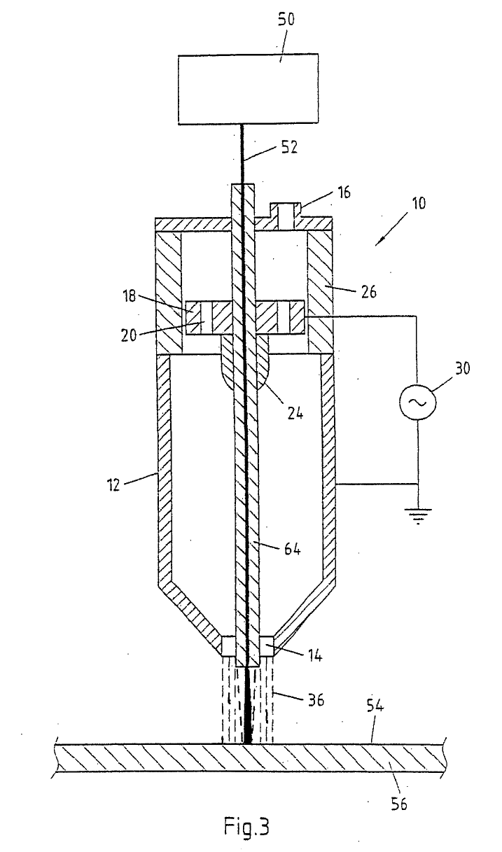

FIG. 3 a third exemplary embodiment of a device according to the invention

Prior to a description of the exemplary embodiments of the device according to the invention for treating a surface with a laser beam and plasma beam, discussion will first be centered on the operation of preferred plasma dies for generating an atmospheric plasma beam.

The plasma die 10 shown on FIG. 1 has a die pipe 12 made of metal, which conically tapers to an outlet opening 14. At the end opposite the outlet opening 14, the die pipe 12 has an inlet 16 for a working gas, e.g., for compressed air. An intermediate wall 18 of the die pipe 12 has a ring of boreholes 20 set at an incline in the peripheral direction, thereby forming a twisting device for the working gas. As a result, the conically tapered part of the die pipe away from the flow is traversed by the working gas in the form of a vortex 22, the core of which runs on the longitudinal axis of the die pipe.

Centrally located on the lower side of the intermediate wall 18 is an electrode 24, which extends coaxially into the tapered section of the die pipe 12. The electrode 24 is formed by a rotationally symmetrical pin that is rounded at the tip, e.g., consisting of copper, which is electrically insulated relative to the intermediate wall 18 and the remaining parts of the die pipe 12 by an insulator 26. A high-frequency alternating voltage generated by a high-frequency transformer 30 is applied to the electrode 24 via an insulated shaft 28.

The voltage is variably controllable, measuring 500 V or more, for example, preferably 2-5 kV, in particular more than 5 kV. The frequency ranges from 0.5 kHz to 50 kHz, for example, preferably measuring 15 to 30 kHz, and is preferably also controllable. Specifically varying the frequency and/or amplitude of the voltage makes it possible to influence the properties of the plasma.

The shaft 28 is connected with the high-frequency transformer 30 via a flexible high-voltage cable 32. The inlet 16 is connected by means of a hose (not shown) with a compressed air source having a variable throughput, which preferably is combined with the high-frequency generator 30 to yield a supply unit. As a result, the plasma die 10 can be moved effortlessly by hand or using a robot arm. The die pipe 12 and the intermediate wall 18 are grounded. The properties of the plasma can also be influenced by specifically varying the throughput.

The applied voltage generates a high-frequency discharge in the form of an arc discharge 34 between the electrode 24 and die pipe 12. However, the twisting flow of the working gas channels this light arc in the vortex core on the axis of the die pipe 12, so that it only branches to the wall of the die pipe 12 in the area of the outlet opening 14. The working gas that rotates at a high flow rate in the area of the vortex core, and hence in direct proximity to the light arc 34, comes into intimate contact with the light arc, and is thereby partially converted into the plasma state, so that a beam 36 of a comparatively cool atmospheric plasma exits the outlet opening 14 of the plasma die 10.

As opposed to FIG. 1, FIG. 2 shows a plasma die that is suitable for performing plasma polymerization. The same reference numbers here denote the same components and features as described previously based on FIG. 1.

In addition to the die and electrode arrangement, the area of the die opening in the exemplary embodiment shown on FIG. 2 provides a lance 40 through which a precursor is allowed in during operation of the plasma die 10. The precursor material is excited in the plasma beam 36 via the introduction of energy and made to react. At least one of the reaction products is then deposited on the surface as a plasma coating.

FIG. 3 shows a plasma die that is very similar to the plasma die shown on FIG. 1, wherein the difference between the two figures essentially lies in the type of arrangement and attachment of a light guide.

The various exemplary embodiments of the device according to the invention for treating the surface of a work piece by means of a laser beam and an atmospheric plasma beam will be described below.

A laser 50 is first provided. In addition, the optical means of the device is a light guide in the form of a fiber or fiber bundle 52 for guiding the laser beam, which exits the light guide and hits the surface 54 of the treated work piece 56. An optical lens system can also be provided instead of a fiber or fiber bundle. However, the use of a fiber or fiber bundle is preferred.

The outlet side of the light guide 52 is directed at the surface area exposed to the plasma 36. This ensures that precisely the area being simultaneously treated with the plasma is exposed to the laser beam. As shown on FIG. 2, the outlet side of the light guide 52 can be provided with an optical system 60 to enlarge the exiting laser beam. In the example shown, the optical system 60 has two lenses, but the number of lenses in the optical system 60 is not prescribed.

FIG. 1 shows that the light guide 52 is connected with the plasma die 10 generating the plasma beam via a mount 62, and hence secured laterally to the plasma die 10. This ensures that the laser beam is always directed at the same solid angle below the die opening 14 as the plasma beam. In the exemplary embodiment shown on FIG. 2, the mount 62 holds the optical system 60.

In the exemplary embodiment depicted on FIG. 3, the light guide 52 is situated in a guide 64 arranged inside the plasma die 10. The guide 64 extends through the entire die arrangement, and preferably consists of a nonconductive material, for example ceramic. The guide 64 can also be shorter, e.g., end inside the die pipe 12.

The plasma is generated around the mount 64, without this significantly limiting the plasma intensity. The special advantage to this arrangement of the light guide 52 is that the light guide 52 is directed axially toward the plasma exposure area 36 on the surface 56, regardless of the distance between the surface and the plasma die. This ensures that the laser beam hits the same area of the surface as the plasma beam.

It is not mandatory that the mounting ring 64 situated inside the plasma die 10 be axially oriented. If the application so requires, the mount 64 can be aligned differently within the die pipe 12.

Three exemplary embodiments were used above to describe the arrangement of a light guide 52. However, the invention is not limited to the use of only one light guide 52, since several light guides or light guide bundles can be used to guide the laser beam.

1. A method for treating a surface of a work piece, in which the surface to be treated is exposed to a beam of electromagnetic radiation, and in which an area of the surface exposed to the beam of electromagnetic radiation is simultaneously exposed at least partially to a plasma beam.

2. The method according to claim 1, in which an area exposed to the plasma beam is completely enveloped by the area exposed to the beam of electromagnetic radiation.

3. The method according to claim 1, in which an area exposed to the plasma beam is larger than the area exposed to the beam of electromagnetic radiation.

4. The method according to claim 1, in which the beam of electromagnetic radiation is aligned essentially parallel to the direction of plasma beam propagation.

5. The method according to claim 1, in which the beam of electromagnetic radiation and the area of the surface exposed to the plasma are subjected to plasma polymerization.

6. The method according to claim 5, in which plasma polymerization takes place alternately with the exposure of the surface to the beam of electromagnetic radiation and the plasma beam.

7. The method according to claim 5, in which plasma polymerization takes place simultaneously with the exposure of the surface to the beam of electromagnetic radiation and the plasma beam.

8. The method according to claim 1, in which a laser beam is used.

9. The method according to claim 1, in which an atmospheric plasma beam is used.

10. A device for treating a surface of a work piece, with means for exposing the surface to be cleaned to a beam of electromagnetic radiation, and with means for at least partially treating an area of the surface exposed to a beam of electromagnetic radiation with a plasma beam.

11. The device according to claim 10, wherein a laser is provided.

12. The device according to claim 10, wherein a plasma die for generating the plasma beam is provided.

13. The device according to claim 10, wherein at least one light guide is provided for guiding the beam of electromagnetic radiation.

14. The device according to claim 13, wherein the light guide is partially situated inside the plasma die.

15. The device according to claim 10, wherein the plasma die has means for introducing a precursor material into the working gas stream or plasma beam.
